(19) United States
(12) Patent Application Publication
(10) Pub. No.: US 2001/0045476 A1
(43) Pub. Date: Nov. 29, 2001

(54) Concaves for gyratory crusher

(75) Inventors: Jeffrey Washburn, Shoreview, MN (US); David L. Wahlgren, Fridley, MN (US)

Correspondence Address: MERCHANT & GOULD PC, P.O. BOX 2903, MINNEAPOLIS, MN, 55402-0903, US

(73) Assignee: ME INTERNATIONAL

(21) Appl. No.: 09/778,570

(22) Filed: Feb. 7, 2001

Related U.S. Application Data
(60) Provisional application No. 60/181,447, filed on Feb. 10, 2000.

(51) Int. Cl. B02C 2/00

(52) U.S. Cl. 241/207

(57) ABSTRACT

In one embodiment, concaves for gyratory crushers are formed in a trapezoidal or triangular shape to achieve essentially three-point contact with an external shell of the gyratory crusher. In a further embodiment, concaves for gyratory crushers are provided with adjustable pads whose position with respect to the back surface of the concave can be changed. In a further embodiment, concaves for gyratory crushers are provided with alignment pads that are inserted between the back surface of the concave and the external shell of the gyratory crusher. In a further embodiment, concaves for gyratory crushers are provided with removable fastening member such as bolts that engage the back surface of the concave to mount the concave to the external shell of the gyratory crusher. The concaves of the present invention can provide secure mounting of the concaves in place to promote longer wear life and are easily removed for replacement.

### BACKGROUND OF THE INVENTION

The present invention is directed to concaves, which are used to line the inner surface of the stationary outer shell of a gyratory crusher. Gyratory crushers typically are used for performing primary crushing of ore from mining operations.

In the primary crushing, large size pieces of ore, for example 6 to 9 feet (2 to 3 meters) in diameter are reduced in size to pieces about 4-12 inches (10-30 cm) in diameter. As seen in FIG. 1, the gyratory crusher has an open top into which the ore to be crushed is dumped, a stationary outer shell 2 and a tapered, gyrating mantle or spindle 6 disposed in the center. The mantle typically is driven from the bottom by an oscillating drive and is supported at its top end by a framework that spans the open top end of the crusher (commonly known as a “spider”).

The diameter of the mantle increases towards the bottom of the crusher. Thus, as the mantle gyrates, pieces of ore are crushed between the mantle and the stationary outer shell of the crusher. The pieces of ore are reduced to smaller and smaller pieces as they work their way downward in the crusher, and finally pass out of the bottom of the crusher through a space between the mantle and the bottom end of the crusher. The size of the pieces discharged from the crusher can be varied by changing the spacing between the mantle and the bottom wall.

The inner surface of the stationary outer shell is lined with rows of wear panels 4 known as “concaves”, which serve as the wear surface for the crushing of the ore. The concaves typically are made of a hard ferrous material, for example austenitic manganese steel, martensitic steel or martensitic white iron.

The concaves typically have been rectangular in form, for example 2 to 3 feet (60-90 cm) wide and 3 to 5 feet (90-150 cm) high. The concaves typically are 2 to 10 inches (5-25 cm) thick, with thicker concaves generally being used for the bottom portions of the crusher. The side edges of the concaves may be provided with slots for accepting gradually tapered pins that are hammered between concaves. This will force the concaves outward and ensure better contact with the outer shell of the crusher.

The concaves generally are secured in place by a system that includes pouring molten material such as plastics or low-melting metals such as zinc behind the concave, i.e., between the concave and the outer shell of the crusher. To create the necessary space for the molten material, the concaves typically are provided with pads on the back surface (for purposes of this application, the back surface of the concave will be considered to be the surface that faces the outer shell of the crusher while the front surface will be considered the surface facing the interior of the crusher). The pads typically have a thickness of about 1/4 inch-1/2 inch (0.5 to 1.5 cm). However, due to the wear and tear of the crushing operation, the outer shell of the crusher may become irregular or deformed after extended use. In addition, the concave itself may have deformations or irregularities. In such cases, the four pads at the four corners of each concave may not be in secure contact with the outer shell of the crusher. This can leave one or more of the corners unsupported, which in turn increases the likelihood that part of the concave may be broken off during use. This decreases the effective life of the concave and also can result in damage to the crusher itself. In addition, the removal and replacement of worn concaves is difficult and time-consuming, resulting in significant down time for the crusher.

### SUMMARY OF THE INVENTION

The present invention provides concaves for gyratory crushers having improved qualities. In one aspect of the invention, the concaves are formed in a generally trapezoidal or triangular shape. In this aspect, a single pad can extend substantially across the width of the short end of the trapezoid or triangle. In another aspect, at least one of the pads on the concave is adjustable, for example taking the form of a threaded bolt with an enlarged head. In a still further aspect of the invention, one or more aligning pads can be inserted between the concave and the shell of the crusher. Different size pads can be used as needed. Also, the aligning pad can be made of a relatively soft material that is capable of deforming to adapt itself to any deformation or irregularity in the external shell of the crusher. In a still further aspect of the invention, the concaves are secured to the external wall of the crusher with a releasable fastener such as a bolt.

### BRIEF DESCRIPTION OF THE DRAWINGS

The present invention is described below in connection with the accompanying drawings, which should be considered as illustrative rather than limiting.

FIG. 1 is a partially sectional side view illustrating the basic configuration of a gyratory crusher.

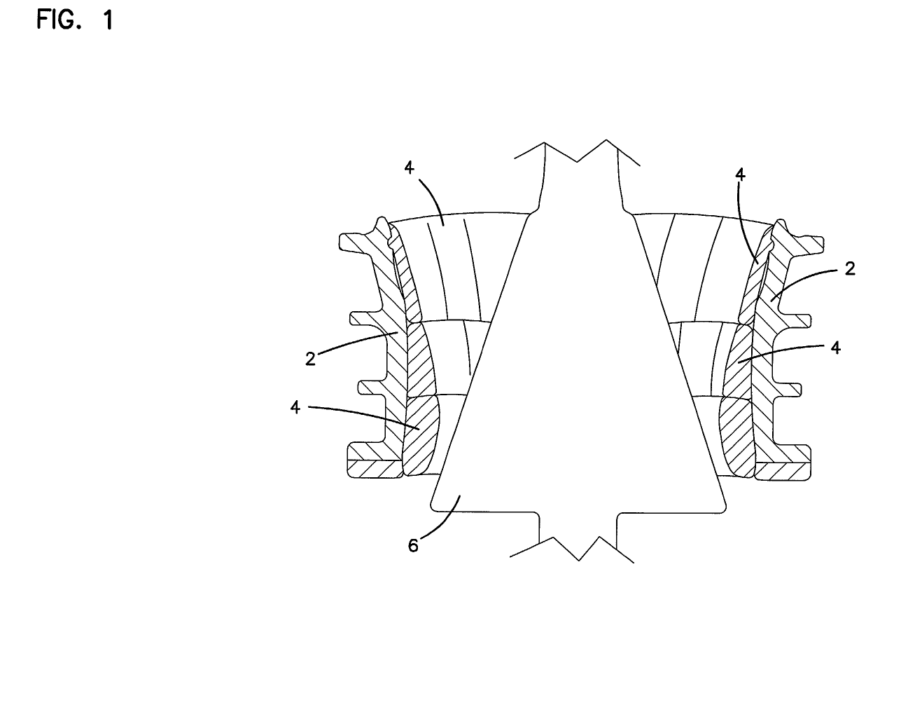

FIGS. 2A and B are back and side views of one embodiment of the present invention making use of trapezoidal-shaped concaves.

FIGS. 3A and B are back and sectional side views of a further embodiment of the present invention making use of a concave with an adjustable pad.

FIGS. 4A and B are top and sectional side views of a still further embodiment of the present invention making use of a concave provide with self-aligning pads.

FIGS. 5A and B are back and sectional side views of a still further embodiment of the present invention making use of a concave mounted to a gyratory crusher with a removable fastener.

### DETAILED DESCRIPTION

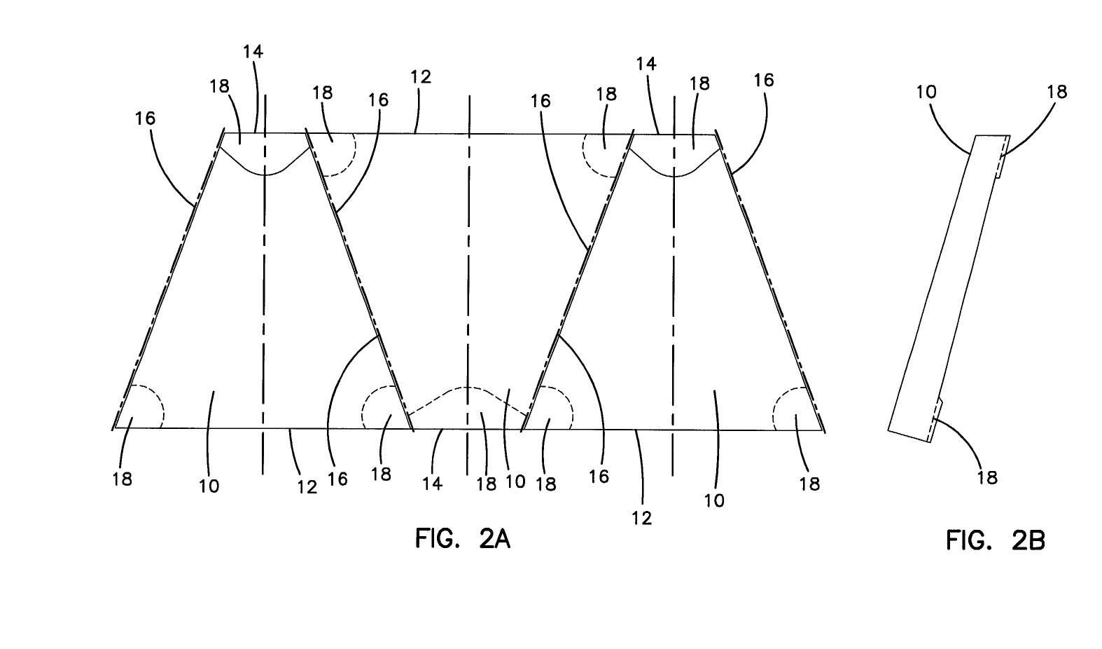

Referring to FIGS. 2A and B, in one aspect of the present invention, the concaves 10 are formed in a generally trapezoidal or triangular shape. These concaves are provided with long ends 12 and short ends 14, joined by sides 16 that form an acute angle with the long ends 12 (for the purposes of a triangular shape, the short end 14 could be considered as substantially a point in form). A pad 18 is provided at each corner defined by the long end and the sides 16. A single pad is provided at the short end 14, substantially extending between the sides 16. This configuration establishes essentially three-point contact between each concave and the external shell of the crusher, thereby permitting accommodation of any deformations or irregularities in the external shell of the crusher or in the concave itself.

The long end of the trapezoidal concave 10 typically will have a dimension similar to the width of the rectangular concaves in current use. The height of the trapezoidal concave 10 typically will be about the same as that of the rectangular concaves. These dimensions are not critical and may be varied as desired. The short end 12 should have a length that is large enough to provide sufficient structural strength to withstand the stress of the crushing operation. The length of the short end 14 typically will be in the range of about 15-40% of the length of the long end 12, preferably about 20-33%, with a minimum length of about 6 inches (15 cm). If the shape is triangular, the angle at the corner corresponding to the short end 14 should be sufficiently large to provide adequate structural strength at that position, i.e. usually an angle greater than about 45°, preferably about 60-75°. The angle between the sides 16 and the long end 12 also should be sufficiently large so that the corners will have sufficient structural strength to withstand the stress of the crushing operation. This should be greater than about 45°, preferably about 60-75°. There is no particular maximum on the angle, although an inherent maximum will be present due to the need to prevent the short end 14 from being too long. If the short end 14 is too long, the advantages of the three-point contact will be lost. Typically, the maximum length of the short end 14 should be no greater than about 18 inches (45 cm), preferably no more than about 12 inches (30 cm).

The pads 18 can have the thickness discussed earlier with respect to the rectangular concaves. While the pad 18 at the short end 14 has been shown extending completely across the short end and between the two sides 16, it is not necessary for the pad to extend completely across the short end, as long as the pad is providing sufficient support to avoid breakage at the short end.

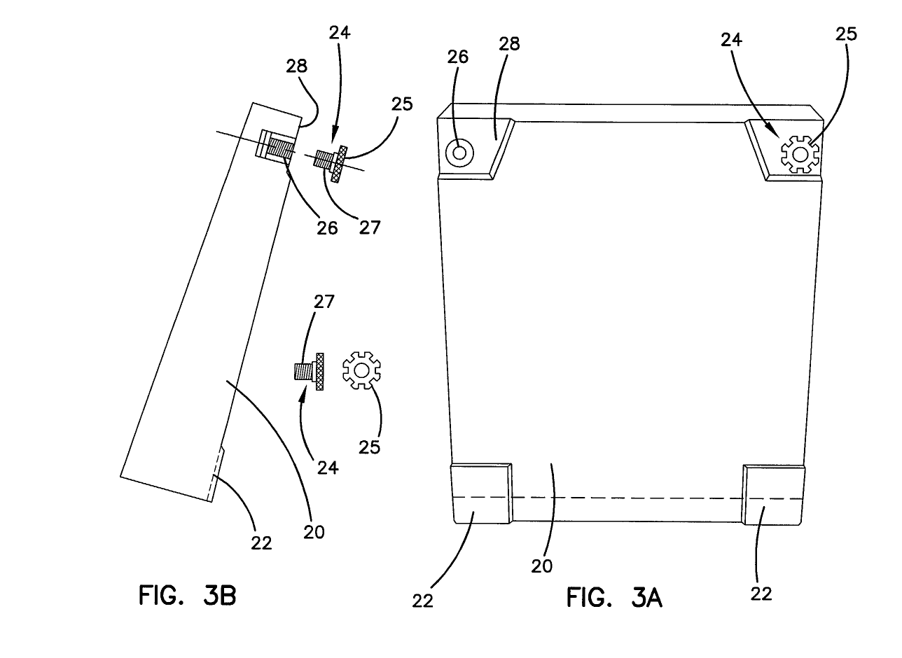

Referring to FIGS. 3A and B, in a further embodiment of the present invention, the concave 20 makes use of an adjustable pad to accommodate deformation or irregularity in the external shell of the crusher. The concave 20 is provided with fixed pads 22, which can be the same as the pads discussed above with respect to the rectangular concaves. The concave also is provided with one or more adjustable pad members 24, which include an enlarged head 25 that acts as a bearing surface. The concave is provided with a threaded opening 26, into which a threaded body 27 of the adjustable pad member is inserted. The enlarged head of the adjustable pad member typically will have a diameter of about 2.5 to 4 inches (6 to 10 cm). The threaded opening 26 can be provided in a recessed portion 28 of the back surface of the concave. The depth of the recessed portion can be the same as the thickness of the enlarged head of the adjustable pad member, although this is not essential.

For installation, the adjustable pad member 24 will be threaded into the opening 26 as far as possible and the concave will be put in place on the external shell of the crusher. If all corners of the concave are not securely contacting the external wall of the crusher, the position of the adjustable pad member can be varied, i.e., moved outward, until secure contact is provided. In the illustrated embodiment, the enlarged head 25 is provided with a plurality of lobes that are capable of engaging the jaws of a spanner. Thus, the spanner can be inserted between the concave and the external shell of the crusher and used to rotate the adjustable pad member 24 until it reaches the proper position. Other systems permitting the adjustment of the pad member 24 can be used as desired. In addition, while the illustrated concave is provided with two adjustable pads, it would be possible to use a single adjustable pad or more than two adjustable pads as desired.

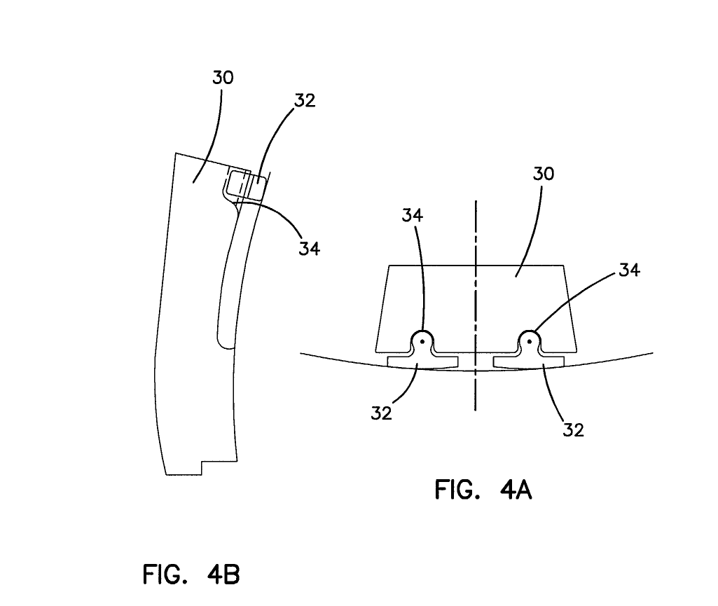

Referring to FIGS. 4A and B, in another embodiment of the present invention, the concave 30 is provided with aligning pads 32. The aligning pads 32 are carried in slots 34 formed in the back surface of the concave. The pads 32 can be inserted, (e.g. dropped into place) after the concave is positioned on the shell of the crusher. Irregularities or deformation of the external shell of the crusher can be accommodated by making use of aligning pads of different sizes. The aligning pad used may be selected from a group of aligning pads of different sizes, depending on the spacing between the back surface of the concave and the crusher. In addition, the aligning pads can be made of a relatively soft material, for example having a hardness less than about 200 HB (Brinell hardness), preferably less than about 150 HB. This permits some deformation of the aligning pads to conform to any irregularities or deformation of the external shell or the concave.

While the illustrated embodiment has two alignment pads, a single alignment pad or more alignment pads could be used if desired. In addition, the concave illustrated in FIGS. 4A and B is of a different general type than that of the other Figures. This is done for illustration purposes, and the use of the alignment pads is not limited to this general configuration, but is applicable to other configurations as well. Similarly, the aspects of the other embodiments of the invention are applicable to concaves having the general configuration shown in FIGS. 4A and B.

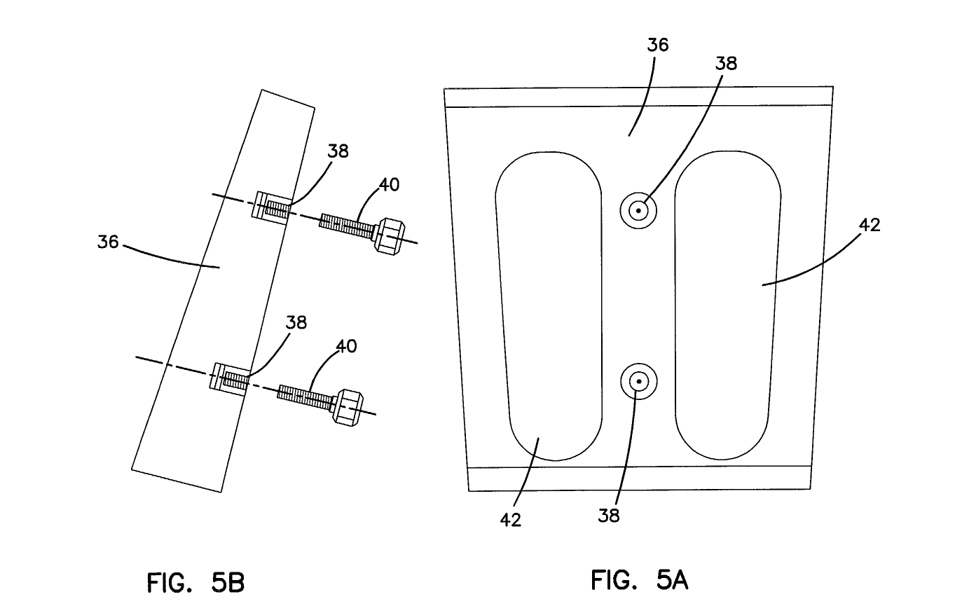

Referring to FIGS. 5A and B, a bolt-in concave 36 is illustrated. The concave 36 is provided with threaded apertures 38, which can accept removable fasteners such as bolts 40. This permits the easy removal of the concave from the external shell of the crusher, since the molten backing material would not be required. While the illustrated embodiment is provided with two apertures and bolts at a central location on the concave, the number and location may be varied as needed. In addition, the illustrated embodiment includes shallow recessed paneling portions 42, which sometimes are used in concaves. The paneling also could be used with the other concaves illustrated in the other Figures as desired.

While individual features have been illustrated in the particular Figures, it will be apparent that these features can be used in various combinations as desired. For example, the adjustable pads in FIGS. 3A and B could be used with a trapezoidal- or triangular-shaped concave of FIGS. 2A and B.

While a detailed description of the invention has been provided above, the present invention is not limited thereto and modifications will be apparent that do not change the spirit of the present invention. Rather, the present invention is defined by the following claims, along with the full scope of equivalents to which the present invention is entitled.

What is claimed is:

1. A concave for a gyratory crusher, comprising a long first end, a short second end, and first and second sides joining the first and second ends, the first and second ends and first and second sides defining a substantially trapezoidal shape, or where the second end is substantially a point and the first and second ends and first and second sides define a substantially triangular shape.

2. A concave as claimed in claim 1, wherein the length of the first end is in the range of about 15-40% of the length of the second end.

3. A concave as claimed in claim 2, wherein the length of the first end is in the range of about 20-33% of the length of the second end.

4. A concave as claimed in claim 2, wherein the second end has a minimum length of about 15 cm.

5. A concave as claimed in claim 1, which is substantially triangular in shape.

6. A concave as claimed in claim 5, wherein the angles at the corners are greater than about 45°.

7. A concave as claimed in claim 2, wherein the length of the first end is no greater than about 45 cm.

8. A concave as claimed in claim 7, wherein the length of the first end is no greater than about 30 cm.

9. A concave for a gyratory crusher, comprising an adjustable pad member having an enlarged head defining a bearing surface, the adjustable pad member being movable with respect to a back surface of the concave.

10. A concave as claimed in claim 9, wherein the concave has a threaded opening and the pad member, has a threaded body and an enlarged head that acts as a bearing surface.

11. A concave as claimed in claim 10, wherein the enlarged head of the adjustable pad member has a diameter of about 6 to 10 cm.

12. A concave as claimed in claim 10, wherein the threaded opening is positioned in a recessed portion on a back surface of the concave.

13. A concave as claimed in claim 12, wherein the depth of the recessed portion is substantially the same as the thickness of the enlarged head of the adjustable pad member.

14. A concave as claimed in claim 10, wherein the enlarged head is provided with a plurality of lobes.

15. A concave for a gyratory crusher, comprising an alignment pad to be inserted into engagement with a back surface of the concave between the concave and an external shell of the gyratory crusher.

16. A concave as claimed in claim 15, wherein the alignment pad is selected from a group of alignment pads of different sizes based on a spacing between the back surface of the concave and an external shell of the gyratory crusher.

17. A concave as claimed in claim 16, wherein the aligning pad is made of a material having a hardness less than about 200 HB (Brinell hardness).

18. A concave as claimed in claim 17, wherein the aligning pad is made of a material having a hardness less than about 150 HB.

19. A concave for a gyratory crusher, comprising a back surface and removable fasteners for engaging the back surface to mount the concave on an external shell of a gyratory crusher.

20. A concave as claimed in claim 19, wherein the back surface of the concave is provided with threaded apertures, which can accept removable threaded fasteners.
